(19) United States
(12) Patent Application Publication
(10) Pub. No.: US 2019/0043137 A1
(43) Pub. Date: Feb. 7, 2019

(54) LOCATION-BASED USER ACTIVITY PLATFORM

(71) Applicant: Bryant Mathis, Tuscaloosa, AL (US)

(72) Inventor: Bryant Mathis, Tuscaloosa, AL (US)

(21) Appl. No.: 16/034,323

(22) Filed: Jul. 12, 2018

Related U.S. Application Data
(60) Provisional application No. 62/531,819, filed on Jul. 12, 2017.

(51) Int. Cl. G06Q 50/00; H04W 4/02; H04L 12/58; H04L 29/08

(52) U.S. Cl. CPC G06Q 50/01; H04L 67/306; H04L 51/32; H04W 4/023

(57) ABSTRACT

Disclosed herein is a location-based user activity matching platform enabled to determine profile data for a first user; process the first user's profile data based on matching rules, the matching rules being configured to analyze profile data from a plurality of users and user groups to determine at least one user satisfying predetermined criteria; determine a set of matching users satisfying the predetermined criteria from the plurality of users groups; notify the first user of the set of matching users; and enable the first user and the set of matching users to interact with one another.

### CROSS REFERENCE TO RELATED APPLICATIONS

This application claims the benefit of priority to U.S. Provisional Patent Application Ser. No. 62/531,819, filed Jul. 12, 2017, which is hereby incorporated herein by reference in its entirety.

### FIELD OF INVENTION

The present disclosure generally relates to matching individuals and groups based on shared profile characteristics, interests, activities, events, and the like.

### BACKGROUND OF THE INVENTION

It is regular practice for individuals to look for to see who among their friends are participating in a shared activity or event, or possible seek out others to engage in the shared activity, event, or experience. For instance, some individuals may want to find people to play basketball with or go to a concert with. Conventionally, individuals may find such people in their social groups that are interested in the same activity or join an organization or club. In addition to being time-consuming, searching for people to participate in an activity may not be an option for people who are new to an area, and can even be limiting for among friends, as social circles consist of a relatively small pool of individuals.

Accordingly, there remains a need for new methods and systems for matching individuals and groups based on interested activities and events. This need and other needs are satisfied by the various aspects of the present disclosure.

### SUMMARY OF THE INVENTION

In accordance with the purposes of the invention, as embodied and broadly described herein, the invention, in one aspect, relates to a location-based user activity or event matching platform. This brief overview is provided to introduce a selection of concepts in a simplified form that are further described below in the detailed description.

In another aspect, the invention relates to a method comprising: determining, by a system having at least one processor, profile data for a first user; processing, by the system, the first user's profile data based on matching rules, the matching rules being configured to at least one of: analyze profile data from a plurality of user groups to determine at least one user group matching profile data provided by the first user, and analyze profile data from a plurality of user groups to determine at least one user group satisfying predetermined criteria selected by the first user, wherein the predetermined criteria comprises at least one parameter associated with at least one of: location data, activity data, group data, and user group data; determining, by the system, a set of matching user groups from the plurality of users based at least on the matching rules satisfying the predetermined criteria; notifying, by the system, the first user of the set of matching user groups; displaying, by the system, the set of matching user groups; receiving a selection to join one or more user groups from the set of matching user groups; determining, by the system, a set of matching users from a plurality of users satisfying predetermined criteria based at least on the one or more selected user groups; notifying, by the system, the first user of the set of matching users; displaying, by the system, the set of matching users; and enabling the first user and the set of matching users to interact with one another.

In another aspect, the invention relates to a method comprising: determining, by a system having at least one processor, profile data for a first user; processing, by the system, the first user's profile data based on matching rules, the matching rules being configured to analyze profile data from a plurality of users to determine at least one user satisfying predetermined criteria; determining, by the system, a set of matching users satisfying the predetermined criteria from the plurality of users; notifying, by the system, the first user of the set of matching users; and enabling the first user and the set of matching users to interact with one another.

In another exemplary aspect, the invention relates to system comprising a memory storage and a processing unit coupled to the memory storage, wherein the processing unit is operative to perform a method having the steps of: determining, by a system having at least one processor, profile data for a first user; processing, by the system, the first user's profile data based on matching rules, the matching rules being configured to analyze input data comprising profile data from a plurality of users to determine at least one user satisfying predetermined criteria; determining, by the system, a set of matching users satisfying the predetermined criteria from the plurality of users; notifying, by the system, the first user of the set of matching users; and enabling the first user and the set of matching users to interact with one another.

In another exemplary aspect, the invention relates to a computer-readable medium comprising a set of instructions which, when executed, perform a method comprising: determining, by a system having at least one processor, profile data for a first user; processing, by the system, the first user's profile data based on matching rules, the matching rules being configured to analyze input data comprising profile data from a plurality of users to determine at least one user satisfying predetermined criteria; determining, by the system, a set of matching users satisfying the predetermined criteria from the plurality of users; notifying, by the system, the first user of the set of matching users; and enabling the first user and the set of matching users to interact with one another.

This brief overview is not intended to identify key features or essential features of the claimed subject matter. Nor is this brief overview intended to be used to limit the claimed subject matter's scope. Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

Additional aspects of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate various aspects and embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicants. The Applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a block diagram of an operating environment in accordance with an exemplary embodiment of the present invention.

FIG. 2 shows a flow chart of a method for providing a location-based activity partner matching platform in accordance with an exemplary embodiment of the present invention.

FIG. 3 shows a block diagram of a system including a computing device for performing a disclosed method in accordance with an exemplary embodiment of the present invention.

FIG. 4 shows a flow chart of a method for providing a location-based activity partner matching platform in accordance with an exemplary embodiment of the present invention.

FIG. 5 shows a screen shot of a user interface for the location-based user activity matching platform in accordance with an exemplary embodiment of the present invention.

FIG. 6 shows a screen shot of a user interface for the location-based user activity matching platform in accordance with an exemplary embodiment of the present invention.

FIG. 7 shows a screen shot of a user interface for the location-based user activity matching platform in accordance with an exemplary embodiment of the present invention.

FIG. 8 shows a screen shot of a user interface for the location-based user activity matching platform in accordance with an exemplary embodiment of the present invention.

### DETAILED DESCRIPTION OF THE INVENTION

The present invention can be understood more readily by reference to the following detailed description of the invention and the Examples included therein.

Before the present articles, systems, devices, and/or methods are disclosed and described, it is to be understood that they are not limited to specific manufacturing methods unless otherwise specified, or to particular materials unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

All publications mentioned herein are incorporated herein by reference to disclose and describe the methods and/or materials in connection with which the publications are cited. As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of activities, embodiments of the present disclosure are not limited to use only in this context.

It is also to be understood that the terminology used herein is for the purpose of describing particular aspects only and is not intended to be limiting. As used in the specification and in the claims, the term “comprising” can include the aspects “consisting of” and “consisting essentially of” Unless defined otherwise, all technical and scientific terms used herein have the same meaning as commonly understood by one of ordinary skill in the art to which this invention belongs. In this specification and in the claims, which follow, reference will be made to a number of terms which shall be defined herein.

As used in the specification and the appended claims, the singular forms “a,” “an” and “the” includes “at least one” and plural referents unless the context clearly dictates otherwise. Thus, for example, reference to “a user” includes two or more users. When used herein to join a list of items, “or” denotes “at least one of the items,” but does not exclude a plurality of items of the list. Finally, when used herein to join a list of items, “and” denotes “all of the items of the list.”

Ranges can be expressed herein as from one particular value, and/or to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

The terms “first,” “second,” “first part,” “second part,” and the like, where used herein, do not denote any order, quantity, or importance, and are used to distinguish one element from another, unless specifically stated otherwise.

As used herein, the terms “optional” or “optionally” means that the subsequently described event or circumstance can or cannot occur, and that the description includes instances where said event or circumstance occurs and instances where it does not. For example, the phrase “optionally affixed to the surface” means that it can or cannot be fixed to a surface.

It is understood that the devices and systems disclosed herein have certain functions. Disclosed herein are certain structural requirements for performing the disclosed functions, and it is understood that there are a variety of structures that can perform the same function that are related to the disclosed structures, and that these structures will typically achieve the same result.

### A. Platform Overview

In accordance with various aspects of the present disclosure, a location-based user and activity matching platform may be provided. This overview is provided to introduce a selection of concepts in a simplified form that are further described below. This overview is not intended to identify key features or essential features of the claimed subject matter. Nor is this overview intended to be used to limit the claimed subject matter's scope.

In further aspects, the location-based user activity matching platform may be used by individuals to match with other individuals based on predetermined criteria in order to perform activities or events (e.g. exercising, drinking, eating, gaming, shopping, or the like) together.

In still further aspects, the platform may enable users to create a profile. Their profile may include user information or data such as, for example, information related to location, group, organization, club, school, name, event, time, age, gender, at least one activity of interest, activity skill level, activity frequency, events, time, calendar data, photographs, images, videos, and audio files. In yet further aspects, the platform may then match the user with other platform users or groups based on the users' profile data, mutual interests, and/or other requirements, as further described herein. In even further aspects, the platform may enable its users to search for known users or other users in matching user groups and/or users with matching interests based on the users' proximity to each other. In still further aspects, each platform user may read their user matches' profiles and interact with those users via the platform, such as by sending a message to those users that they may want to participate in a shared activity or event with.

In further aspects, the platform may process profile data based on matching rules which may include at least one of: analyzing predetermined selection criteria provided by a first user with profile data from the plurality of users; analyzing predetermined selection criteria and/or profile data provided by a first user with profile data associated with a plurality of user groups; analyzing a first user's profile data with profile data from the plurality of users; and analyzing predetermined criteria provided by at least one user from the plurality of users with the first user's profile data. In still further aspects, processing the profile data based on matching rules may include at least one of: analyzing predetermined criteria and/or profile data provided by a first user with profile data from the plurality of users to identify a set of matching users; analyzing predetermined criteria and/or profile data provided by a first user with profile data from a plurality of user groups to identify a set of matching user groups; analyzing a first user's profile data with profile data from the plurality of users to identify a set of matching users; analyzing predetermined criteria provided by at least one user from the plurality of users with the first user's profile data to identify a set of matching users; reducing a size of a matching user set by applying at least one filter; and reducing a size of a matching user group set by applying at least one filter. In yet further aspects, the least one filter may include at least one of: applying a matching algorithm; applying a folding routine; eliminating matching users from a matching user set having profile data comprising a predetermined parameter; eliminating matching user groups from a matching user group set having profile data comprising a predetermined parameter; and eliminating matching users that are present in a controlled library; and eliminating matching user groups that are present in a controlled library.

In further aspects, the platform may determine profile data may comprise at least one of: location, group, organization, club, school, name, age, gender, at least one activity of interest, activity skill level, activity frequency, time, event, calendar data, at least one photograph, image, video, and audio file. In still further aspects, determining the profile data can comprise determining, by the platform, profile data based on a user's answers to a questionnaire. In some aspects, determining the profile data can comprise determining profile data based on a first user's answers to a questionnaire. In yet further aspects, determining the profile data can comprise receiving profile data from a third-party platform comprising information associated with a user. In even further aspects, determining the profile data can comprise receiving profile data from a third-party platform comprising information associated with a user. In some aspects, profile data of the plurality of users may be determined using a user's answers to a questionnaire. In other aspects, profile data of the plurality of users may be determined using data from a third-party platform comprising information associated with the plurality of users.

In further aspects, the platform may notify one or more users. In still further aspects, notifying may comprise at least one of: notifying a user of at least one matching user and/or user group; displaying a set of matching users and/or a set of matching user groups. In still further aspects, notifying may comprise at least one of: displaying a location of at least one user from the set of matching users in a graphical interface, such as a map; displaying the location of a plurality of users from the set of matching users in a graphical interface, such as a map. In even further aspects, the graphical interface may be a dashboard configures to display various textual or visual representations of the platform and data. In some aspects, the displayed users may be based on a first user's proximity to the displayed users. In other aspects, the displayed users may be represented on the graphical interface using a symbol, character, image, or the like. In various further aspects, selecting a displayed user may further comprise displaying the selected user's profile.

In further aspects, the matching or displayed users may be organized or aggregated using at least one common or matching criteria selected from at least one of: location data, activity type, activity data, group data, group type, user group type, activity data, activity type, calendar data, duration, start time, stop time, and custom criteria provided by a user. For example, the matching or displayed users can be aggregated together by location to see other relevant information of users in the desired area, and then by activity type, and so forth. In still further aspects, a list of matching or displayed users can be modified by applying one or more filters. In yet further aspects, the display filter can include at least one of: applying a matching algorithm; applying user selected options; hiding displayed users having profile data comprising a predetermined parameter selected by a user; hiding displayed users that are present in a controlled library; and hiding displayed user groups having profile data comprising a predetermined parameter selected by a user.

While the users and activities can be chosen from a list, users can create custom user groups and activities and then can be grouped under their preexisting activities and/or groups. In further aspects, the platform may enable creation a non-reciprocal user group comprising at least one non-matching member selected by the first user. In still further aspects, a user to transmit a connection request or invitation to another user for establish a friend user relationship, such as to one or more unmatched users. In even further aspects, friend user relationship provides definable platform privileges associated with friend user interaction, communication and platform activity. For example, if a first user updates in the platform that they are at a gym, it will show that they are at that gym, and any other platform user authorized to view the first user's platform activities, such as users belonging to a shared user group, for example members of that particular gym, and are looking to go to the gym will see that the first user is at the gym. In various aspects, the platform is configured to enable users to know who is available to participate in shared user activities at same time.

In various aspects, the platform can enable user interaction between users of the platform. In still further aspects, enabling interaction can comprise enabling a first user and the set of matching users to interact with one another. In still further aspects, the platform can further comprise facilitating a communication between a first user and at least one user from the set of matching users. In yet further aspects, the platform can further comprise facilitating a communication between the first user and a plurality of users from the set of matching users. In some aspects, facilitating a communication may comprise enabling a first user and at least one user from the matching user set to schedule a shared activity or event. In other aspects, facilitating the communication can comprise enabling a first user and a plurality of users from the matching user set to schedule one or more activities or events.

In further aspects, user interaction can comprise at least one of: transmitting a message, transmitting a post, sharing content, and the like. In still further aspects, the content can comprise at least one of: textual, graphical content, video content, and audio content. In even further aspects, enabling the first user can comprise providing the first user with a listing of activities. In still further aspects, providing the listing of activities can comprise providing at least one of the following: locations; group information, events, activities, and venues; or the like. In yet further aspects, the platform can further comprise presenting data and information related to the activities.

In some aspects, the profile data can comprise at least one of: location, group, organization, club, school, name, age, gender, at least one activity of interest, activity skill level, activity frequency, event, calendar data, and at least one photograph, image, video, and audio file. In other aspects, the predetermined criteria can comprise at least one of: location, group, organization, club, school, name, age, gender, at least one activity of interest, activity skill level, activity frequency, event, duration, start time, stop time, date, day(s), user, user group, photographs, images, video, audio; and the like.

In further aspects, the selected predetermined criteria or profile data can be changed at any desired time. In still further aspects, the system is configured to update matching users and/or activities in real time in response to changes in the predetermined criteria and/or profile data and display updated results. For example, changes in location and/or activity type may cause the matching users and/or activities to be updated. In yet further aspects, each predetermined criterion can have a predetermined time duration or time period.

In further aspects, the platform can further comprise determining a set of user groups from a plurality of user groups matching group data associated with profile data of the first user, notifying the first user of the at least one matching user group, displaying the set of matching user groups, and enabling the user to enroll or join one or more user groups from among the set of matching user groups. In still further aspects, a user group can comprise at least one of: a reciprocal user group and a non-reciprocal user group. For example, platform can generate a non-reciprocal user group comprising one or users selected by the first user. In yet further aspects, a reciprocal user group can comprise a user group where all users in the group have joined the group or have received membership in the group. In still further aspects, enrollment in a reciprocal group can be based at least one shared element or data associated with user profile data. In even further aspects, a user composition in a non-reciprocal user group may be determined by a user or the system, or a combination thereof.

In further aspects, a non-reciprocal user group can be generated by a user by selecting at least one other user for inclusion in the non-reciprocal user group. In still further aspects, the selected users included in the non-reciprocal user group are initially only visible to the user generating the non-reciprocal user group. In yet further aspects, a user composition in a non-reciprocal user group is initially only visible to the user generating the non-reciprocal user group. In even further aspects, a user composition in a non-reciprocal user group is initially only visible to the user generating the non-reciprocal user group. In still further aspects, the user generating the non-reciprocal user group can enable the selected users to enroll or join the non-reciprocal user group. For example, enabling the selected users to enroll or join the non-reciprocal user group can comprise transmitting an invitation to join the non-reciprocal user group. In even further aspects, the selected user in the non-reciprocal user group can then view the users associated with non-reciprocal user group upon enrollment in the non-reciprocal group. In some aspects, predetermined criteria can comprise a non-reciprocal use group as a criterion. For example, the selected users can be based at least on a geofence established by a zone, area or set of coordinates selected by the first user. A group could be created based on users in a given location or who are doing same activity or event. Geo-fencing can be applied as a grouping feature or search parameter. The non-reciprocal group can be an existing group customized by user by adding 1 or more known users not in the existing group, not found to be a matching user, or that the customizing user desires to be included as part of an activity search or activity matching process.

In various aspects, the predetermined criteria can have at least one predetermined time duration or time period. In further aspects, the predetermined time duration can be from about 1 minute to about 24 hours, or more. In still further aspects, the time period can be a period between 12 A.M. and 12 P.M., for example, from 4 P.M. to 6 P.M. In yet further aspects, a plurality of predetermined time durations or time periods can be selected. To this end, each predetermined criterion can have a predetermined time duration or time period. For example, a user can select a limited time period for a given location which corresponds to the time period that the user expects to be in that given location and can select a different time period or duration for certain activity type that can be played under certain outdoor conditions, such as during daylight. In further aspects, the time parameter of the platform can enable a user to find activity matches with other users the moment of searching, or the can select search activity parameters that include a time in the future and be matched with anyone who has chosen the same time frame and other matching criteria. In some aspects, the platform can utilize user calendars for events or future events. To this end, the platform can take advantage of matching another user's calendar linked to the platform.

In various aspects, the platform is enabled for user interaction between one user and at least one other user. In further aspects, enabling can be user interaction between the first user and at least one other user from among the set of matching users. In yet further aspects, enabling can be user interaction between users within a user group. In some aspects, user interaction can comprise at least one of: transmitting a message, transmitting a post, and sharing content. In other aspects, the content can comprise at least one of: textual, graphical content, video content, and audio content.

In further aspects, the platform is enabled to allow a user to transmit a connection request or invitation to another user for establish a friend user relationship, such as “friending”, “send an invitation to become friends”, and/or “requesting to follow another user.” In still further aspects, a first user can transmit a connection request or invitation to at least one unmatched user for establish a friend user relationship. In still further aspects, the friend user relationship provides definable platform privileges associated with friend user interaction, communication and platform activity. For example, “friends” may be users who have agreed to allow one another to have a connection and relationship on the platform. Thus, a “friend list” can comprise a collection of users who have agreed to allow others to be there friends and have both been added to one another friend list, and thus, allow the friend to be included among matching users in activity searches. In this respect, friend users connected to a user or a “friends list” can comprise a non-reciprocal group.

In further aspect, the platform can comprise various platform activity performed by a user. In still further aspects, the platform activity can comprise viewing shared user content, viewing posted user content, and receiving notification of platform activity of a user, and the like. In yet further aspects, posted content can comprises content that is designated to a user group or channel and remains visible in the designated user group or channel according to the posting parameters within that user group or channel. In yet further aspects, matching content comprises content visibility that can based on matched users. Sharing post content can comprise sharing content that is shared and specified at the moment of sharing, such as what the channel and information will be displayed and continue to be displayed through that channel. For example, post content can be shared with a geo-tag to be associated with a selected location and any user and/or search meeting the location criteria would be able to see the shared post content. Sharing matching content can comprise sharing content for sharing globally to matching users or user groups according to the platform and other parameters, where the content is visible for the matched users and or user groups. The platform can comprise both the ability to share post content and matching content.

Unlike traditional social media or messaging platforms, platforms of the present disclosure may enable users to schedule activities of mutual interest, for example, by using combinations of location, activity, and group data. In further aspects, upon selection of a feature of the platform that one user would like to meet another user, the platform may provide the user with a listing of activities that match with that user. The listing of activities may be an up-to-date listing of certain events, activities, or venues that may be of interest to the users. In this way, unlike conventional platforms, the platform of the present disclosure may enable users to engage with each other beyond the ordinary textual/media messaging functionality. Moreover, as will be detailed below, the platform may connect with users in certain groups or community forums, or create groups based on a common trait or characteristic.

The platform may provide benefits including: time, users will spend less time searching for others to do an activity; convenience, as a user's schedule may require the activity to be done at a time that no one he or she currently knows is available; companionship, for example, if a user is new to a city/locale—has just moved there or in-town on business—and doesn't know anyone to perform the activity with; motivation, for example, if a user needs the accountability of another person or group of people to help propel him or her to continue the activity or attain a new goal; face to face interaction, user can enjoy doing the activity with others versus alone, and knowing who, what, and where at a glance. In further aspects, the platform allows for connecting users doing the same activities or interested in doing the same activities at the same time, and in various specified groups or combination of groups.

Current methods for information sharing do not allow for the specificity, scale efficiency and ease of the disclosed platform. Current processes send media through set channels or ridged channels that do not change and if are changed effect the channel of information received by other parties. While the type of information can be sent through the various channels can change, the receiving parties are often strictly set. In further aspects, the present platform can allow for a changing of channels that reaches different users based upon information inputted to the system and arranged by, but not limited to, the disclosed process. This allows information to be shared and formatted according to user preferences.

In further aspects, the platform may comprise a collaborative calendar associated with a number of users through a number of different calendar platforms or manually input information. In turn, the collaborative calendar may be accessed by the platform to indicate related schedules and/or view related schedules. Accordingly, the collaborative calendar may provide access to related schedules of a large number of users corresponding to geographical area, and the like. For instance, users may be able to view related schedules corresponding to a region of a city. By analyzing scheduling information from the collaborative calendar, the described techniques may be able to match future events and activities between users.

For instance, analysis of scheduling information in the collaborative calendar may indicate, for example, that a large number of users are planning to attend a sporting event at a stadium. Further, in case the scheduling information in the collaborative calendar includes information such as one or more of time/day, location, etc., a more accurate event or activity matching can take place. Additionally, data associated with events and venues may be retrieved in order to assist in the activity searches and matches.

In further aspects, methods of the present platform can efficiently allow sending of information to a different party in the context that information has no value to a party until it is read or responded to with different degrees of value from the party that sent the message. In many aspects, the sender does not know the status or relevance of the information they are sending to the other party. The disclosed platform allows for information to be sent to those who are relevant and available for the information and provides both the sender and other parties with value from shared information. In still further aspects, in current methods, information about a person's status regarding what they are doing is static and can be outdated. The present platform can allow users to acquire current information and share precise information in a safe and simple manner. In even further aspects, the present platform provides a means of sharing information (ex., sending messages) to selected groups and selected individuals, allowing groups to be formed for a specific purpose, thus allowing a user to communicate information or content to those in a shared group, including only content relevant to the purpose of the specific group. Information not relevant to the entire group is sent through current methods and is only meant for a number of individuals in the main group the others receive the information not necessarily pertaining to them or to reach those select individuals a new group can be formed. This leads to an inefficient system that focus information of all types and relevance go through a channel that is built around one purpose to reach the users in that group. The invention allows for the sharing of information to the individuals in a group without having to send irrelevant information to others or create a new channel to reach specific members of main group. Users of current social media platforms are relegated to the restricted communication means set by the platform for how information is shared with others. For example, using current group messaging, a person in a shared message group may send a message about a shared activity intended for or that may be relevant to only 1 or 2 persons in the shared message group, but would be still be received by all the persons in shared message group. In order to contact only the relevant persons about the shared activity without messaging the entire shared message group, a new message group would need to be formed. For example, someone in a shared mountain biking group could post a request or content to the shared group related to go out to eat, and person in the shared group who are not interested in going to eat would still receive information unrelated to their desired activities and/or schedules, and the like. As described herein, the platform of the present disclosure allows for more control and flexibility in how information related to activities, events, and users is shared and utilized.

Although the present disclosure references “activities” as, for example, but not limited to, working out, drinking, eating, gaming, or shopping, it should be understood that “activities” can include events, and expansions and modifications rendered thereto are within the anticipated scope of this disclosure. In various aspects, an event can comprise an activity having a defined time period, duration, start time and/or end time. To the end, events may appear within the platform for fixed period of time, and no longer appear after the end time.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### B. Platform Configuration

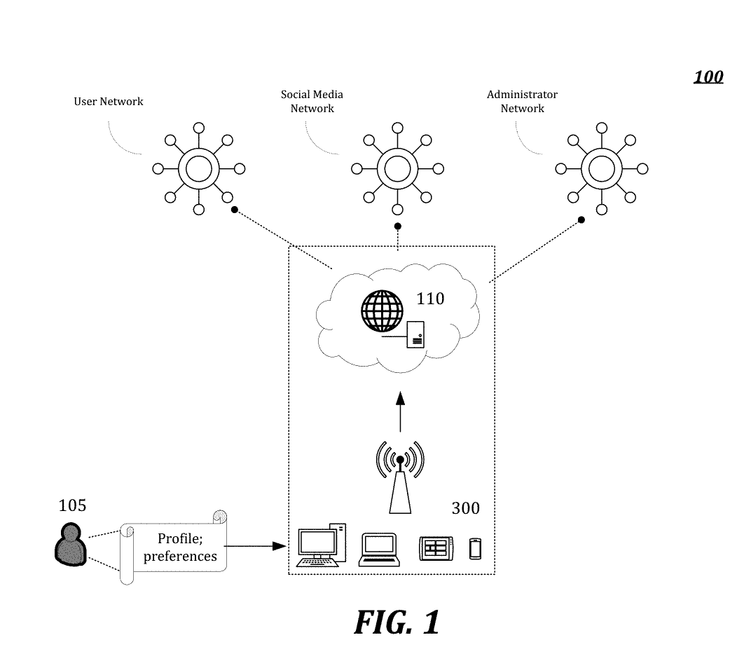

In various aspects, FIG. 1 illustrates one possible operating environment through which a platform consistent with embodiments of the present disclosure may be provided. By way of non-limiting example, a platform 100 may be hosted on a centralized server 110, such as, for example, a cloud computing service. A user 105 may access platform 100 through a software application. The software application may be embodied as, for example, but not be limited to, a website, a web application, a desktop application, and a mobile application compatible with a computing device.

Platform 100 may provide an online interface for enabling users to interact with the platform. Such an online interface may be configured to receive user login and profile information. Further, the online interface may be configured to enable a user to search through his or her user and user group matches and interact with matched users and other user within his or her corresponding user groups.

Moreover, platform 100 may provide an application interface that may be accessed with devices such as, for example, a desktop, laptop, smartphone or tablet device. The various applications that are adapted to each of these devices may be configured to communicate with server 110 perform the same function as the aforementioned online interface. In embodiments where the device has location tracking technology, the application may provide the platform with location information using location detection methods associated with the device, such as, for example, GPS, Wi-Fi and cell tower triangulation.

In addition to the platform interfacing with users through stand-alone website or application, or it may interface with users through social media as a social media app/plug-in/or software otherwise compatible with a social media Application Programming Interface (API). In this way, employing the API, the platform may retrieve user information (e.g., friends, interests, events, and the like) form a third party social media platform (e.g., Facebook). Furthermore, the platform may interface with users through an administrator platform that may provide additional privileges to administrators.

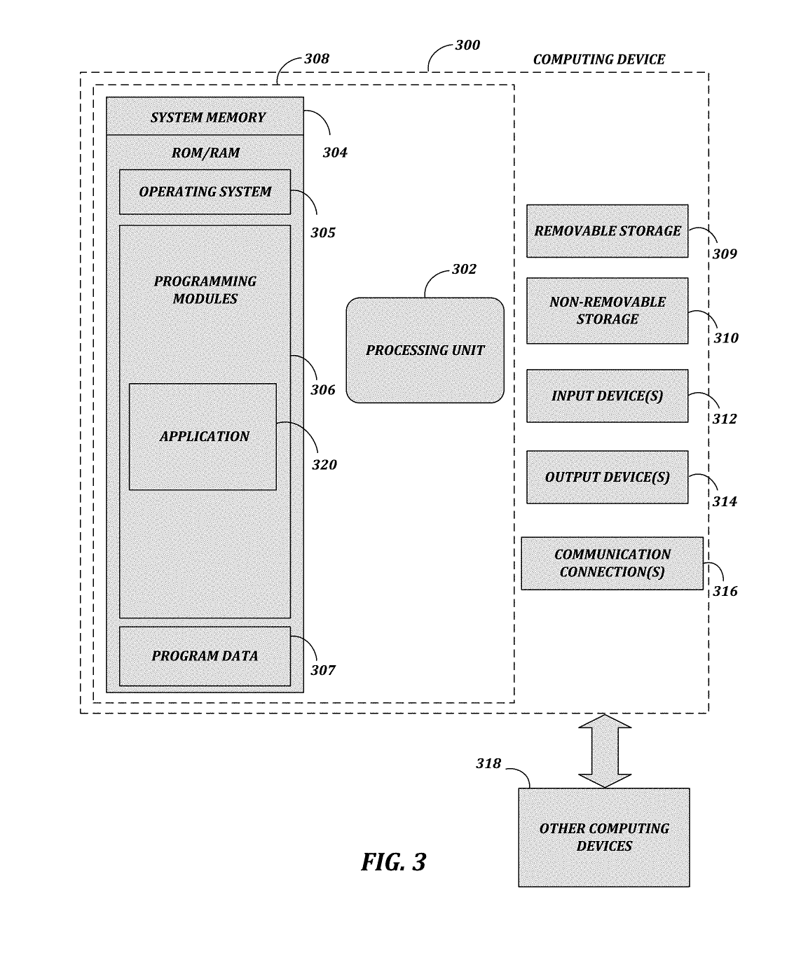

As will be detailed with reference to FIG. 3 below, the computing device through which the platform may be accessed may comprise, but not be limited to, for example, a desktop computer, laptop, a tablet, or mobile telecommunications device. In yet further embodiments, the computing device may comprise a smart-watch or smart-glasses adapted for mobile computing. Though the present disclosure is written with reference to a mobile telecommunications device, it should be understood that any computing device may be employed to provide the various embodiments disclosed herein.

### C. Platform Operation

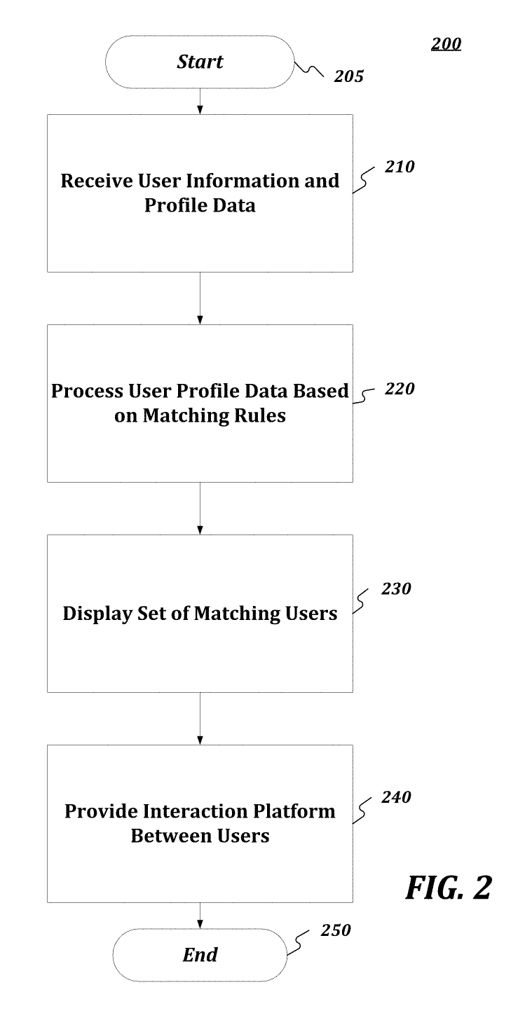

In various aspects, FIG. 2 is a flow chart setting forth the general stages involved in a method 200 consistent with an embodiment of the disclosure for providing platform 100. Method 200 may be implemented using a computing device 300 as described in more detail below with respect to FIG. 3.

Although method 200 has been described to be performed by platform 100, it should be understood that computing device 300 may be used to perform the various stages of method 200. Furthermore, in some embodiments, different operations may be performed by different networked elements in operative communication with computing device 300.

Although the stages illustrated by the flow charts are disclosed in a particular order, it should be understood that the order is disclosed for illustrative purposes only. Stages may be combined, separated, reordered, and various intermediary stages may exist. Accordingly, it should be understood that the various stages illustrated within the flow chart may be, in various embodiments, performed in arrangements that differ from the ones illustrated. Moreover, various stages may be added or removed from the flow charts without altering or deterring from the fundamental scope of the depicted methods and systems disclosed herein. Ways to implement the stages of the disclosed methods will be described in greater detail below.

Method 200 may begin at starting block 205 and proceed to stage 210 where platform 100 may receive user information and/or input data from a user. For example, a user may create and register a profile. The profile may contain user information and data such as, for example, information related to location, group, organization, club, school, name, age, gender, at least one activity of interest, activity skill level, activity frequency, calendar data, scheduling data, event data, image data, video data, audio data, and the like. The profile may further contain information, such as, for example, contact information, a description of the user, predetermined selection criteria or preferences that can be used by the system to determine potential matches (e.g., location within a specified radius, group or organization membership, user groups, gender, category of activities, etc.). The platform may receive at least a portion of this information by providing a questionnaire and receiving responses from the user.

In some embodiments, the profile information may be populated from data received from a social media platform. For example, as mentioned above, the platform of the present disclosure may be configured to interface with a third-party social media platform over an API. Employing the API, the platform may retrieve user-data that is available to the social media platform. In this way, the platform user may select to have, for example, their Facebook or Instagram profile pictures, likes, interests, and friends available for use with the present application.

In some embodiments, platform 100 may receive information from one or more “collaborative calendars” and/or information entered by the user. For example, platform 100 may receive information from Google Calendar. Such information may include scheduling data, such as information related to a time of an appointment and/or location for the appointment. The location may be, for example, an address, place or a set of GPS coordinates. Further, the platform may receive user current location information. For example, the platform may receive user GPS coordinates from the user's mobile phone. Such information may be used to predict when and where a user may for matching future activities and events.

From stage 210, where platform 100 receives user information, method 200 may advance to stage 220 where platform 100 may process data, such as, based on predetermined criteria, selection criteria or parameters, matching rules, and the like. For example, platform 100 may match users with user groups based on the extent to which the group data from the user correspond with each user groups. Platform 100 may in addition or in the alternative, match users based on the extent to which each other's profiles correspond with each user's preferences. Matching rules may comprise excluding users from matches whose profiles do not match each other's preferences and/or excluding user groups whose profile data does not match a user's provided profile data. In addition, matching rules may comprise a proprietary algorithm that corresponds to type and quantity of preferences that match between users.

Once platform 100 processes data based on rules in stage 220, method 200 may continue to stage 230 where a computing device, such as computing device 300, may notify or display a set of matching users and/or user groups. For example, the platform may present on one user's device a list matching user groups and/or a list or map of other matching users. The platform may first present on a first user's device a list matching user groups, and then present a list or map of matching users and/or activities based on user groups selected by the first user. The list and/or map may be organized according to user preferences. Further, the platform may enable the user to select one or more of his matches to receive more information about the selected matches. In addition, the platform may notify a user of a new match, for example, with a message, sound or vibration from his or her device which is connected to the platform 100.

In various aspects, a dashboard may be provided to display various visual representations of the match results. In further aspects, a standard set of views and templates may be used to display the matched users and user groups and/or the associated data. In still further aspects, the dashboard may allow users to set configuration properties to customize the customized visual presentations, views, graphs, and/or charts. In yet further aspects, these configurations may include, for example, filter feature, an attribute identifier, single or multiple, aggregate function, default and customizable labels. The dashboard may also include the ability to define baselines for various parameters (e.g., location or time period), which may be used to provide real-time notifications relating to matching users and/or activities.

After platform 100 notifies users of a match in stage 230, method 200 may proceed to stage 240 where platform 100 may provide a platform for interaction between users. For example, the platform may provide a direct messenger between users. Further, the platform 100 may present the users with information pertaining to their preferred activities or events, such as, for example, location, activity rules, advertising, special offers, pricing, promotions, tips, articles, pictures and other information related to the activity.

In some aspects, the platform may provide a group chat or message board for a given user group or activity within a user's matches, profile and/or preferences. The group chat or message board may enable users to share content such as posts, text, images, videos, etc., as well as view content by shared by others within their user groups. For example, if users having matching profile data related to a fraternity and select to enroll in a user group associated with a certain fraternity, they become a part of that “fraternity user group” within a network of other users associated with platform 100 and can share and interact more efficiently, thus allowing for more engagement amongst all the users.

In some aspects, upon providing the platform with an indication that one user would like to participate in an activity with another user, the platform may provide the user with a listing of activities that may be of interest. The listing of activities may be an up-to-date listing of certain events, activities, or venues that may be of interest to the users. Once computing device, such as computing device 300, provides a platform for interaction between users in stage 240, method 200 may then end at stage 250.

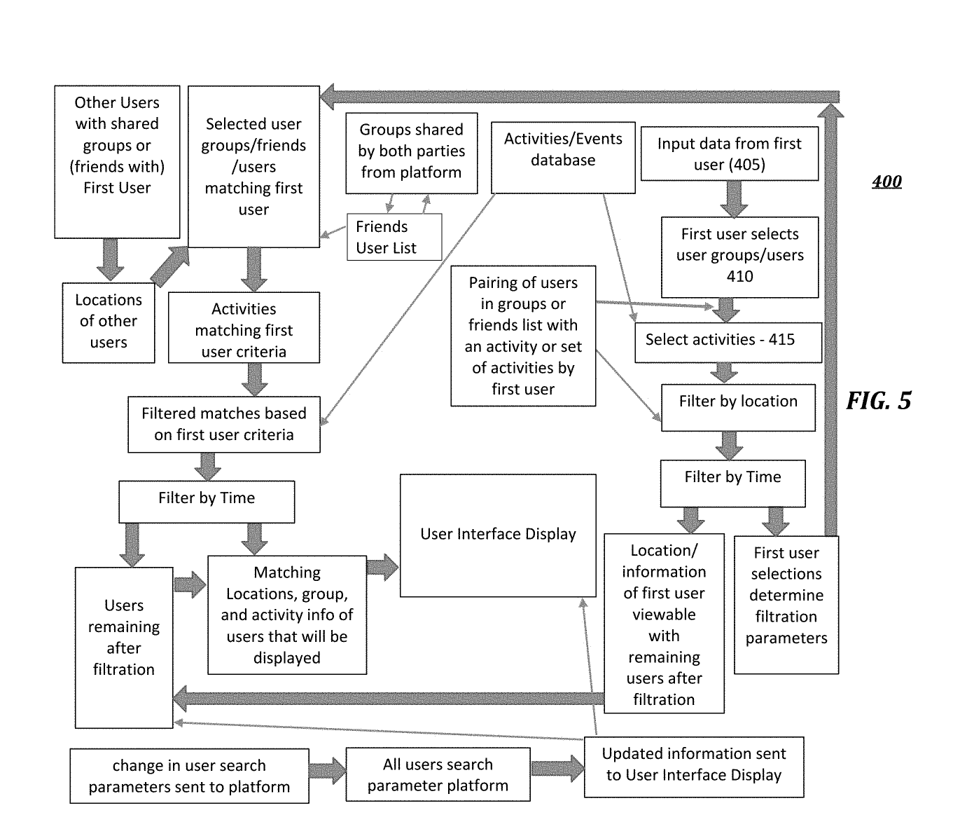

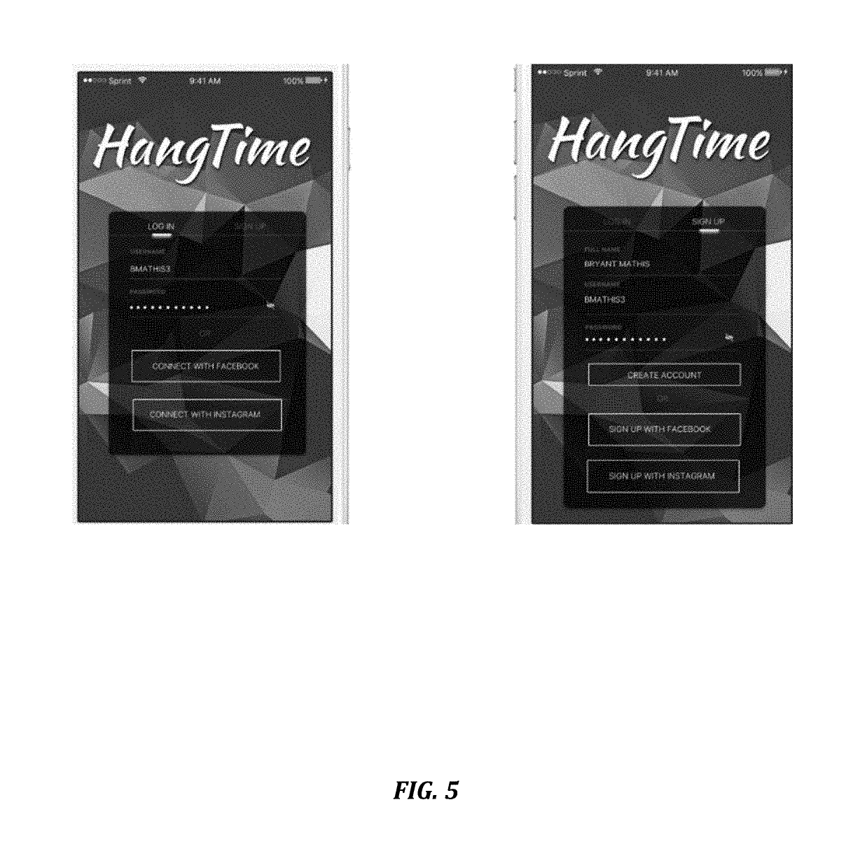

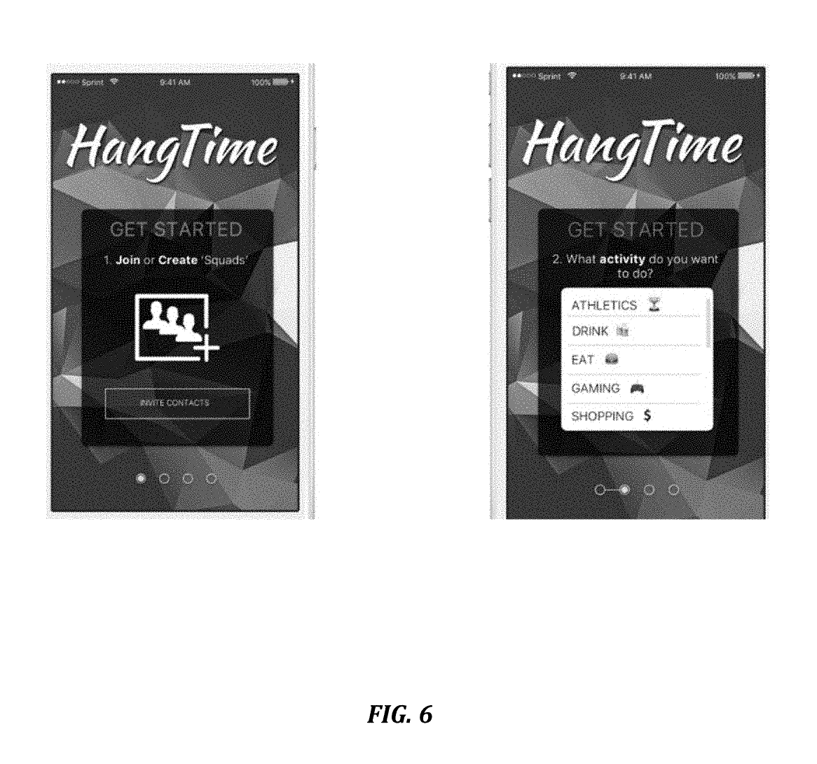

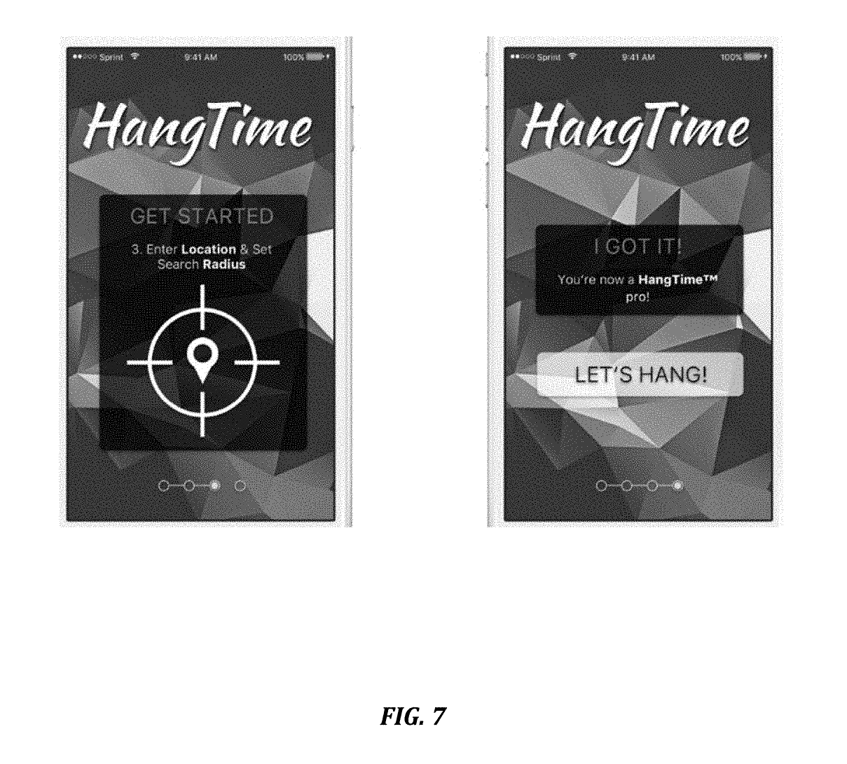

In further aspects, FIG. 4 shows a flow chart setting forth the general stages involved in a method 400 consistent with another exemplary embodiment of the disclosure for providing platform 100. As shown in FIG. 4, the method 400 of this embodiment may be a filtration of people based on three separate criteria. For example, in order for a users' location and profile to appear on another user's display, the user must have at least one of: selected to enroll in one or more shared user groups; selected one or more of the same activities and activity parameters; and location parameter chosen by the user. Thus, once the criteria are met, the locations may be shared and displayed with all users who corresponded with the criteria. As further explained with respect to FIGS. 5-8, the matching users may appear on a map, where the matching users' location pins displayed on the map may act as a window to their entire user profile, providing information related to their selected activity interests and/or parameters that matched those chosen by the user, as well as that not matching those chosen by the user.

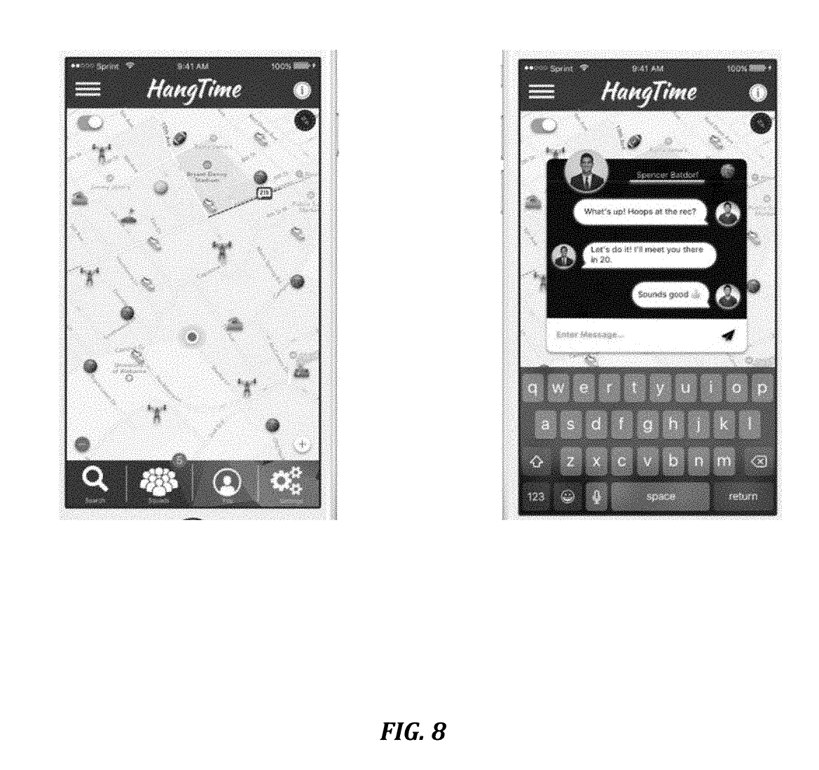

In various aspects, FIGS. 5-8 illustrate exemplary embodiment of a user interface (UI) that can be provided by the platform. In one aspect, FIGS. 5-7 illustrate an exemplary embodiment of an initial user interface (UI) that can be provided by the platform. The initial UI can be used as an interface for a user to create and register a profile. The profile may contain user information such as, for example, location, group, organization, club, school, name, age, gender, at least one activity of interest, activity skill, activity frequency, calendar data, scheduling information, photographs, videos, and audio. The profile may further contain information, such as, for example, contact information, a description of the user, and predetermined criteria or preferences for potential matches (e.g. location within a specified radius, group or organization membership, gender, category of activities, etc.). The platform may receive this information by providing a questionnaire and receiving responses from the user or using a third party social media platform. The UI can comprise various input fields and buttons to enable the user to provide data and choice to guides underlying user and activity matching. As show in FIG. 8, the user profile data can be processed and analyzed with other user profile data to identify and display a set of matching users and/or activities on a map. On the map display, the users' location pins can act as a window to their profile, providing information such as activity interest that match those chosen by the user. Furthermore, the platform then allows the user and the set of matching users to interact with one another, such as by messaging.

### D. Platform Architecture

In various aspects, the platform 100 may be embodied as, for example, but not be limited to, a website, a web application, a desktop application, and a mobile application compatible with a computing device. The computing device may comprise, but not be limited to, a desktop computer, laptop, a tablet, or mobile telecommunications device. Moreover, the platform 100 may be hosted on a centralized server, such as, for example, a cloud computing service. It should be understood that, in some embodiments, different operations may be performed by different networked elements in operative communication with computing device 300.

Embodiments of the present disclosure may comprise a system having a memory storage and a processing unit. The processing unit coupled to the memory storage, wherein the processing unit is configured to perform the stages of the disclosed methods.

In various aspects, method 200 or 400 may be implemented using, at least in part, a computing device 300, such as controller (e.g., on-board computing device) as described in more detail below with respect to FIG. 3. Computing device 300 may comprise an integrated controller for performing the various stages of the disclosed method 200 and operational tasks, including, but not limited to, user matching and parameters, and communication. Furthermore, in some embodiments, different operations may be performed by different networked elements in operative communication with computing device 300.

Furthermore, although stages are disclosed with reference to computing device 300, it should be understood that a plurality of other components may enable the operation of the disclosed methods, including, but not limited to, other computing components, mechanical components, environment properties (e.g., temperature), user conditions, and the like.

Moreover, the computing device, such as controller 300, may be in operative communication with a centralized server, such as, for example, a cloud computing service. Although operation has been described to be performed, in part, by a computing device 300, it should be understood that, in some embodiments, different operations may be performed by different networked elements in operative communication with computing device 300. In further aspects, embodiments of the present disclosure may comprise a system having a memory storage and a processing unit. The processing unit may be coupled to the memory storage, wherein the processing unit is configured to perform the stages of method 200 or 400.

FIG. 3 is a block diagram of a system including a computing device 300. Consistent with an embodiment of the disclosure, the aforementioned memory storage and processing unit may be implemented in a computing device 300, such as controller. Any suitable combination of hardware, software, or firmware may be used to implement the memory storage and processing unit. For example, the memory storage and processing unit may be implemented with computing device 300 or any of other computing device 318, in combination with computing device 300. The aforementioned system, device, and processors are examples and other systems, devices, and processors may comprise the aforementioned memory storage and processing unit, consistent with embodiments of the disclosure.

With reference to FIG. 3, a system consistent with an embodiment of the disclosure may include a computing device 300, such as controller. In a basic configuration, computing device 300 may include at least one processing unit 302 and a system memory 304. Depending on the configuration and type of computing device, system memory 304 may comprise, but is not limited to, volatile (e.g. random access memory (RAM)), non-volatile (e.g. read-only memory (ROM)), flash memory, or any combination. System memory 304 may include operating system 305, one or more programming modules 306, and may include a program data 307. Operating system 305, for example, may be suitable for controlling controller 300's operation. In one embodiment, programming modules 306 may include controller application (“app”) 320, and user-matching modules, communication modules and interface modules. Furthermore, embodiments of the disclosure may be practiced in conjunction with a graphics library, other operating systems, or any other application program and is not limited to any particular application or system. This basic configuration is illustrated in FIG. 3 by those components within a dashed line 308.

Advantageously, the app may provide a user with information as well as be the user's interface to operating the embodiment of the invention. The app may include one or more graphic user interfaces (GUIs). Among the GUIs of the app may be a GUI allowing the user to pick which, if there is more than one, activities and/or events to participate in, and to select (if available) one or more operating parameters or characteristics (such as location, group, organization, club, school, name, age, gender, at least one activity of interest, activity skill, activity frequency, etc.) of the platform. The user may be able to adjust such selections from a GUI of the app.

The GUI may include additional or other information relating to the platform such as a map data with displayed users represented on the map using a symbol, character, image, or the like. The app may also present the user with information received from the platform or other users, such as messages and notifications.

Computing device 300 may have additional features or functionality. For example, computing device 300 may also include additional data storage devices (removable and/or non-removable) such as, for example, magnetic disks, optical disks, or tape. Such additional storage is illustrated in FIG. 3 by a removable storage 309 and a non-removable storage 310. Computer storage media may include volatile and nonvolatile, removable and non-removable media implemented in any method or technology for storage of information, such as computer readable instructions, data structures, program modules, or other data. System memory 304, removable storage 309, and non-removable storage 310 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 300. Any such computer storage media may be part of device 300. Computing device 300 may also be operative with input device(s) 312 such as a keyboard, a mouse, a pen, a sound input device, a touch input device, etc. Input device(s) 312 may be used to, for example, manually access and program computing device 300. Output device(s) 314 such as a display, speakers, a printer, etc. may also be included. The aforementioned devices are examples and others may be used.

Computing device 300 may also contain a communication connection 316 that may allow a device with a controller, such as computing device 300 to communicate with other computing and wireless devices 318, such as over an encrypted network in a distributed computing environment. Communication connection 316 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, Bluetooth, radio frequency (RF), infrared, and other wireless media. The term computer readable media as used herein may include both storage media and communication media.

As stated above, a number of program modules and data files may be stored in system memory 304, including operating system 305. While executing on processing unit 302, programming modules 306 (e.g., user-matching or controller application 320) may perform processes including, for example, one or more of stages or portions of stages of the disclosed methods as described above. The aforementioned process is an example, and processing unit 302 may perform other processes. Other programming modules that may be used in accordance with embodiments of the present disclosure may include electronic mail and contacts applications, word processing applications, spreadsheet applications, database applications, slide presentation applications, drawing or computer-aided application programs, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The present disclosure includes at least the following aspects: Aspect 1: A method comprising: determining, by a system having at least one processor, profile data for a first user; processing, by the system, the first user's profile data based on matching rules, the matching rules being configured to at least one of: analyze profile data from a plurality of user groups to determine at least one user group matching profile data provided by the first user, and analyze profile data from a plurality of user groups to determine at least one user group satisfying predetermined criteria selected by the first user, wherein the predetermined criteria comprises at least one parameter associated with at least one of: location data, activity data, group data, and user group data; determining, by the system, a set of matching user groups from the plurality of users based at least on the matching rules satisfying the predetermined criteria; notifying, by the system, the first user of the set of matching user groups; displaying, by the system, the set of matching user groups; receiving a selection to join one or more user groups from the set of matching user groups; determining, by the system, a set of matching users from a plurality of users satisfying predetermined criteria based at least on the one or more selected user groups; notifying, by the system, the first user of the set of matching users; displaying, by the system, the set of matching users; and enabling the first user and the set of matching users to interact with one another.

Aspect 2: A method comprising: determining, by a system having at least one processor, profile data for a first user; processing, by the system, the first user's profile data based on matching rules, the matching rules being configured to analyze profile data from a plurality of users to determine at least one user satisfying predetermined criteria selected by the first user, the predetermined criteria comprising at least one of: location data, activity data, and group data; determining, by the system, a set of matching users from the plurality of users satisfying the predetermined criteria; notifying, by the system, the first user of the set of matching users; displaying, by the system, the set of matching users; and enabling the first user and the set of matching users to interact with one another.

Aspect 3: The method of any preceding aspect, wherein processing the profile data based on matching rules includes at least one of: analyzing, by the system, predetermined criteria provided by the first user with profile data from the plurality of users; analyzing, by the system, the first user's profile data with profile data from the plurality of users; and analyzing, by the system, predetermined criteria provided by at least one other user from the plurality of users with the first user's profile data.

Aspect 4: The method of any preceding aspect, further comprising receiving modified criteria from at least one of: the first user, at least one other user, and the system; and determining, by the system, an updated set of matching users satisfying the modified criteria.

Aspect 5: The method of any preceding aspect, wherein the updated set of matching users is determined in real-time.

Aspect 6: The method of any preceding aspect, wherein processing the profile data based on matching rules includes at least one of: analyzing, by the system, predetermined criteria provided by the first user with profile data from the plurality of users to identify a set of matching users; analyzing, by the system, a first user's profile data with profile data from the plurality of users to identify a set of matching users; analyzing, by the system, predetermined criteria provided by at least one user from the plurality of users with the first user's profile data to identify a set of matching users; and reducing, by the system, a size of a matching user set by applying at least one filter.

Aspect 7: The method of any preceding aspect, wherein the at the least one filter includes at least one of: applying, by the system, a matching algorithm; applying, by the system, a folding routine; eliminating, by the system, matching users having profile data comprising a predetermined parameter; and eliminating, by the system, matching users that are present in a controlled library.

Aspect 8: The method of any preceding aspect, wherein the predetermined criteria comprises at least one of: a selection criteria duration and a match duration.

Aspect 9: The method of any preceding aspect, wherein the selection criteria duration comprises a time duration associated with at least one selection criterion among the predetermined criteria for use in determining a match.

Aspect 10: The method of any preceding aspect, wherein the match duration comprises a time duration for accessing a match.

Aspect 11: The method of any preceding aspect, wherein determining the profile data comprises determining, by the system, at least one of: location, group, organization, club, school, name, age, gender, at least one activity of interest, activity skill, activity frequency, activity duration, time, event, and at least one photograph.

Aspect 12: The method of any preceding aspect, wherein determining the profile data comprises determining, by the system, profile data based on a user's answers to a questionnaire.

Aspect 13: The method of any preceding aspect, wherein determining the profile data comprises determining, by the system, profile data based on the first user's answers to a questionnaire.

Aspect 14: The method of any preceding aspect, wherein determining the profile data comprises receiving, by the system, the profile data from a third-party platform comprising information associated with a user.

Aspect 15: The method of any preceding aspect, wherein determining the profile data comprises receiving, by the system, the profile data from a third-party platform comprising information associated with the first user.

Aspect 16: The method of any preceding aspect, wherein the profile data of the plurality of users is determined, by the system, using a user's answers to a questionnaire.

Aspect 17: The method of any preceding aspect, wherein the profile data of the plurality of users is determined, by the system, using data from a third-party platform comprising information associated with a user.

Aspect 18: The method of any preceding aspect, wherein notifying comprises displaying, by the system, the location of at least one user from the set of matching users on a map.

Aspect 19: The method of any preceding aspect, wherein notifying comprises displaying, by the system, the location of a plurality of users from the set of matching users on a map.

Aspect 20: The method of any preceding aspect, wherein displaying the set of matching users comprises displaying the matching users on a map.

Aspect 21: The method of any preceding aspect, wherein a location of each of the displayed users is based at least on the first user's proximity to each of the displayed users.

Aspect 22: The method of any preceding aspect, wherein the displayed users are represented on the map using at least one of: a symbol, avatar, character, and image.

Aspect 23: The method of any preceding aspect, wherein the displayed users are organized or aggregated using at least one common or matching criteria selected from at least one of: location data, activity type, activity data, group data, group type, activity data, and activity type.

Aspect 24: The method of any preceding aspect, further comprising modifying, by the system, a size of the displayed users by applying at least one filter.

Aspect 25: The method of any preceding aspect, wherein the at the least one display filter includes at least one of: applying, by the system, a matching algorithm; applying, by the system, user selected options; hiding, by the system, displayed users having profile data comprising a predetermined filter parameter selected by the first user; and hiding, by the system, displayed users present in a controlled library.

Aspect 26: The method of any preceding aspect, wherein selecting a displayed user further comprises displaying, by the system, the selected user's profile.

Aspect 27: The method of any preceding aspect, further comprising facilitating, by the system, a communication between the first user and at least one user from the set of matching users.

Aspect 28: The method of any preceding aspect, further comprising facilitating, by the system, a communication between the first user and a plurality of users from the set of matching users.

Aspect 29: The method of any preceding aspect, wherein facilitating the communication comprises enabling, by the system, the first user to simultaneously transmit a communication to all matching users.

Aspect 30: The method of any preceding aspect, wherein facilitating the communication comprises enabling, by the system, the first user to simultaneously transmit a communication to a selected plurality of user from the set of matching users.

Aspect 31: The method of any preceding aspect, wherein facilitating the communication comprises enabling, by the system, the first user to transmit a communication to a selected user from the set of matching users.

Aspect 32: The method of any preceding aspect, wherein facilitating a communication comprises enabling, by the system, the first user and at least one user from the matching user set to schedule an activity.

Aspect 33: The method of any preceding aspect, wherein facilitating the communication comprises enabling, by the system, the first user and a plurality of users from the matching user set to schedule at least one activity.

Aspect 34: The method of any preceding aspect, wherein enabling the first user comprises providing, by the system, the first user with a listing of activities.

Aspect 35: The method of any preceding aspect, where providing the listing of activities comprises providing, by the system, at least one of the following: events, activities, and venues; or the like.

Aspect 36: The method of any preceding aspect, further comprising presenting data and information related to the activities.

Aspect 37: The method of any preceding aspect, wherein the profile data comprises at least one of: location, group, organization, club, school, name, age, gender, time, event, at least one activity of interest, activity skill, activity frequency, and at least one photograph, image, video, and audio file.

Aspect 38: The method of any preceding aspect, wherein the profile data comprises selected group and selected activity.

Aspect 39: The method of any preceding aspect, wherein the predetermined criteria is at least one of: location data, activity data, and group data.

Aspect 40: The method of any preceding aspect, wherein the predetermined criteria comprises at least one of: location, group, organization, club, school, name, age, gender, time, event, at least one activity of interest, activity skill, activity frequency, and at least one photograph, image, video, and audio file.

Aspect 41: The method of any preceding aspect, wherein the selected predetermined criteria can be changed at any desired time.

Aspect 42: The method of any preceding aspect, wherein the selected predetermined criteria or profile data can be changed at any desired time.

Aspect 43: The method of any preceding aspect, wherein matching users and displayed users are updated, by the system, in real time in response to changes in the predetermined criteria or profile data, or a combination thereof.

Aspect 44: The method of any preceding aspect, wherein the matching users and displayed results based on the predetermined criteria are updated in real time in response to changes in the predetermined criteria or profile data, or a combination thereof.

Aspect 45: The method of any preceding aspect, wherein at least one criterion from the predetermined criteria has a predetermined time duration or time period.

Aspect 46: The method of any preceding aspect, wherein the predetermined time duration is from about 1 minute to about 24 hours, or more.

Aspect 47: The method of any preceding aspect, wherein the time period is a period between 12 A.M. and 12 P.M.

Aspect 48: The method of any preceding aspect, wherein each predetermined criterion can have a predetermined time duration or time period.

Aspect 49: The method of any preceding aspect, further comprising determining, by the system, a set of user groups from a plurality of user groups matching group data associated with profile data of the first user; notifying, by the system, the first user of the at least one matching user group; displaying, by the system, the set of matching user groups; and enabling the first user to enroll or join one or more user groups from among the set of matching user groups.

Aspect 50: The method of any preceding aspect, wherein a user group can comprise at least one of: a reciprocal user group and a non-reciprocal user group.

Aspect 51: The method of any preceding aspect, further comprising generating, by the system, a non-reciprocal user group comprising at least one member selected by the first user.

Aspect 52: The method of any preceding aspect, wherein a reciprocal user group comprises a user group where all users in the group have joined the group or have received membership in the group.

Aspect 53: The method of any preceding aspect, wherein enrollment in a reciprocal group is based at least one shared element or data associated with user profile data.

Aspect 54: The method of any preceding aspect, wherein a user composition in a non-reciprocal user group is determined by a user or the system.

Aspect 55: The method of any preceding aspect, wherein a non-reciprocal user group is generated by a user by selecting at least one other user for inclusion in the non-reciprocal user group.

Aspect 56: The method of any preceding aspect, wherein the selected users included in the non-reciprocal user group are initially only visible to the user generating the non-reciprocal user group.

Aspect 57: The method of any preceding aspect, wherein a user composition in a non-reciprocal user group is initially only visible to the user generating the non-reciprocal user group.

Aspect 58: The method of any preceding aspect, wherein a user composition in a non-reciprocal user group is initially only visible to the user generating the non-reciprocal user group.

Aspect 59: The method of any preceding aspect, wherein the user generating the non-reciprocal user group can enable the selected users to enroll or join the non-reciprocal user group.

Aspect 60: The method of any preceding aspect, wherein enabling the selected users to enroll or join the non-reciprocal user group comprises transmitting an invitation to join the non-reciprocal user group.

Aspect 61: The method of any preceding aspect, wherein the selected user in the non-reciprocal user group can view users can view the users associated with non-reciprocal user group upon enrollment in the non-reciprocal group.

Aspect 62: The method of any preceding aspect, wherein predetermined criteria further comprises a non-reciprocal use group as a criterion.

Aspect 63: The method of any preceding aspect, wherein the selected users are based at least on a geofence established by a zone, area or set of coordinates selected by the first user.

Aspect 64: The method of any preceding aspect, further comprising enabling user interaction between one user and at least one other user.

Aspect 65: The method of any preceding aspect, further comprising enabling user interaction between the first user and at least one other user from among the set of matching users.

Aspect 66: The method of any preceding aspect, further comprising enabling user interaction between users within a user group.

Aspect 67: The method of any preceding aspect, wherein user interaction can comprise at least one of: transmitting a message, transmitting a post, and sharing content.

Aspect 68: The method of any preceding aspect, wherein the content comprises at least one of: textual, graphical content, video content, and audio content.

Aspect 69: The method of any preceding aspect, further comprising enabling, by the system, a user to transmit a connection request or invitation to another user for establish a friend user relationship.

Aspect 70: The method of any preceding aspect, further comprising enabling, by the system, the first user to transmit a connection request or invitation to at least one unmatched user for establish a friend user relationship.

Aspect 71: The method of any preceding aspect, wherein the friend user relationship provides definable platform privileges associated with friend user interaction, communication and platform activity.

Aspect 72: The method of any preceding aspect, wherein friend users connected to a user comprises a non-reciprocal group.

Aspect 73: The method of any preceding aspect, wherein the platform activity comprises viewing shared user content, viewing posted user content, and receiving notification of platform activity of a user, and the like.

Aspect 74: The method of any preceding aspect, wherein posted content comprises content that is designated to a user group or channel and remains visible in the designated user group or channel according to the posting parameters.

Aspect 75: The method of any preceding aspect, wherein matched content comprises content visibility is based on shared membership in a user group.

Aspect 76: A system comprising a memory storage and a processing unit coupled to the memory storage, wherein the processing unit is operative to perform the method of any preceding aspect.

Aspect 77: A computer-readable medium comprising a set of instructions which, when executed, perform a method comprising: determining, by a system having at least one processor, profile data for a first user; processing, by the system, the first user's profile data based on matching rules, the matching rules being configured to at least one of: analyze profile data from a plurality of user groups to determine at least one user group matching profile data provided by the first user, and analyze profile data from a plurality of user groups to determine at least one user group satisfying predetermined criteria selected by the first user, wherein the predetermined criteria comprises at least one parameter associated with at least one of: location data, activity data, group data, and user group data; determining, by the system, a set of matching user groups from the plurality of users based at least on the matching rules satisfying the predetermined criteria; notifying, by the system, the first user of the set of matching user groups; displaying, by the system, the set of matching user groups; receiving a selection to join one or more user groups from the set of matching user groups; determining, by the system, a set of matching users from a plurality of users satisfying predetermined criteria based at least on the one or more selected user groups; notifying, by the system, the first user of the set of matching users; displaying, by the system, the set of matching users; and enabling the first user and the set of matching users to interact with one another.

Aspect 78: A computer-readable medium comprising a set of instructions which, when executed, perform a method comprising: determining, by a system having at least one processor, profile data for a first user; processing, by the system, the first user's profile data based on matching rules, the matching rules being configured to analyze profile data from a plurality of users to determine at least one user satisfying predetermined criteria; determining, by the system, a set of matching users satisfying the predetermined criteria from the plurality of users; notifying, by the system, the first user of the set of matching users; and enabling the first user and the set of matching users to interact with one another.

Aspect 79: The computer-readable medium of any preceding aspect, wherein the profile data comprises determining at least one of: location, group, organization, club, school, name, age, gender, at least one activity of interest, activity skill, activity frequency, and at least one photograph.

Aspect 80: The computer-readable medium of any preceding aspect, wherein the predetermined criteria comprises at least one of: location, group, organization, club, school, name, age, gender, at least one activity of interest, activity skill, activity frequency, and at least one photograph.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way appreciably intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications are referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present invention is not entitled to antedate such publication by virtue of prior invention. Further, the dates of publication provided herein can be different from the actual publication dates, which can require independent confirmation.

The patentable scope of the invention is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed:

1. A method comprising:
determining, by a system having at least one processor, profile data for a first user;
processing, by the system, the first user's profile data based on matching rules, the matching rules being configured to at least one of: analyze profile data from a plurality of user groups to determine at least one user group matching profile data provided by the first user, and analyze profile data from a plurality of user groups to determine at least one user group satisfying predetermined criteria selected by the first user, wherein the predetermined criteria comprises at least one parameter associated with at least one of: location data, activity data, group data, and user group data;
determining, by the system, a set of matching user groups from the plurality of users based at least on the matching rules satisfying the predetermined criteria;
notifying, by the system, the first user of the set of matching user groups;
displaying, by the system, the set of matching user groups;
receiving a selection to join one or more user groups from the set of matching user groups;
determining, by the system, a set of matching users from a plurality of users satisfying predetermined criteria based at least on the one or more selected user groups;
notifying, by the system, the first user of the set of matching users;
displaying, by the system, the set of matching users; and
enabling the first user and the set of matching users to interact with one another.

2. The method of claim 1, wherein processing the profile data based on matching rules includes at least one of: analyzing, by the system, predetermined criteria provided by the first user with profile data from the plurality of users; analyzing, by the system, the first user's profile data with profile data from the plurality of users; and analyzing, by the system, predetermined criteria provided by at least one other user from the plurality of users with the first user's profile data.

3. The method of claim 2, further comprising receiving modified criteria from at least one of: the first user, at least one other user, and the system; and determining, by the system, an updated set of matching users satisfying the modified criteria.

4. The method of claim 3, wherein the updated set of matching users is determined in real-time.

5. The method of claim 4, wherein processing the profile data based on matching rules includes at least one of: analyzing, by the system, predetermined criteria provided by the first user with profile data from the plurality of users to identify a set of matching users; analyzing, by the system, a first user's profile data with profile data from the plurality of users to identify a set of matching users; analyzing, by the system, predetermined criteria provided by at least one user from the plurality of users with the first user's profile data to identify a set of matching users; and reducing, by the system, a size of a matching user set by applying at least one filter.

6. The method of claim 5, wherein the selection criteria duration comprises a time duration associated with at least one selection criterion among the predetermined criteria for use in determining a match.

7. The method of claim 6, wherein the match duration comprises a time duration for accessing a matched user or activity.

8. The method of claim 7, wherein determining the profile data comprises determining, by the system, profile data based on a user's answers to a questionnaire; and wherein notifying comprises displaying, by the system, the location of a plurality of users from the set of matching users on a map.

9. The method of claim 8, wherein the displayed users are organized or aggregated using at least one common or matching criteria selected from at least one of: location data, activity type, activity data, group data, group type, activity data, and activity type.

10. The method of claim 9, wherein facilitating the communication comprises at least one of enabling, by the system, the first user to simultaneously transmit a communication to a selected plurality of user from the set of matching users; and enabling, by the system, the first user and at least one user from the matching user set to schedule an activity.

11. The method of claim 10, wherein the profile data comprises selected group and selected activity; and wherein the predetermined criteria is at least one of: location data, activity data, and group data.

12. The method of claim 11, wherein the matching users and displayed results based on the predetermined criteria are updated in real time in response to changes in the predetermined criteria or profile data, or a combination thereof.

13. The method of claim 12, further comprising generating, by the system, a non-reciprocal user group comprising at least one member selected by the first user; and wherein the non-reciprocal user group is generated by a user by selecting at least one other user for inclusion in the non-reciprocal user group.

14. The method of claim 13, wherein the selected users included in the non-reciprocal user group are initially only visible to the user generating the non-reciprocal user group or wherein the selected users are based at least on a geofence established by a zone, area or set of coordinates selected by the first user.

15. The method of claim 14, further comprising enabling user interaction between the first user and at least one other user from among the set of matching users within a user group; and wherein user interaction can comprise at least one of: transmitting a message, transmitting a post, sharing posted content, and sharing matched content.

16. The method of claim 15, further comprising enabling, by the system, a user to transmit a connection request or invitation to another user for establish a friend user relationship.

17. The method of claim 16, wherein posted content comprises content that is designated to a user group or channel and remains visible in the designated user group or channel according to the posting parameters.

18. The method of claim 16, wherein matched content comprises content visibility based on shared membership in a user group and user preferences of user in the user group.

19. A computer-readable medium comprising a set of instructions which, when executed, perform a method comprising:
determining, by a system having at least one processor, profile data for a first user;
processing, by the system, the first user's profile data based on matching rules, the matching rules being configured to at least one of: analyze profile data from a plurality of user groups to determine at least one user group matching profile data provided by the first user, and analyze profile data from a plurality of user groups to determine at least one user group satisfying predetermined criteria selected by the first user, wherein the predetermined criteria comprises at least one parameter associated with at least one of: location data, activity data, group data, and user group data;
determining, by the system, a set of matching user groups from the plurality of users based at least on the matching rules satisfying the predetermined criteria;
notifying, by the system, the first user of the set of matching user groups;
displaying, by the system, the set of matching user groups;
receiving a selection to join one or more user groups from the set of matching user groups;
determining, by the system, a set of matching users from a plurality of users satisfying predetermined criteria based at least on the one or more selected user groups;
notifying, by the system, the first user of the set of matching users;
displaying, by the system, the set of matching users; and
enabling the first user and the set of matching users to interact with one another.

20. The computer-readable medium of claim 19, wherein the profile data comprises determining at least one of: location, group, organization, club, school, name, age, gender, at least one activity of interest, activity skill, activity frequency, and at least one photograph.
